(19) United States
(12) Patent Application Publication
(10) Pub. No.: US 2021/0001861 A1
(43) Pub. Date: Jan. 7, 2021

(54) ROAD TYPE RECOGNITION

(71) Applicant: Byton North America Corporation, Santa Clara, CA (US)

(72) Inventor: Olivier Lobey, San Jose, CA (US)

(21) Appl. No.: 16/504,216

(22) Filed: Jul. 5, 2019

(51) Int. Cl. B60W 40/068

(52) U.S. Cl. CPC B60W 40/068; B60W 2560/02; B60W 2520/10; B60W 2550/147; B60W 2530/20; B60W 2520/30; B60W 2420/42; B60W 2520/26; B60W 2550/13; B60W 2550/406; B60W 2420/54

(57) ABSTRACT

A vehicular road type recognition system analyzes data relating to road condition from sensors. The system determines an estimate or a correction of vehicle range, vehicle maximum safe speed, or vehicle braking distance.

### FIELD

A vehicular road type recognition system is described. In particular the system analyzes data from one or sensors relating to road condition and estimates at least one of a vehicle range, a vehicle maximum safe speed, or a braking distance.

### BACKGROUND

Trip computers in vehicles track distance traveled and estimate vehicle range based on gas mileage (for gasoline engine vehicles or similarly for diesel engine vehicles), battery charge (for electric vehicles), or both (for hybrid or plug-in electric hybrid vehicles). Manufacturers, or various third-party sources, often publish performance data or estimates of vehicle performance, including maximum speed, cornering force, acceleration and stopping distances from one or more speeds. Tires are rated for maximum safe operating speed. All these estimates may be based on ideal real-world, test or hypothetical conditions. Yet the real world is seldom ideal, and a driver may make a mistake relying on such estimates, for example and have the vehicle run out of electric charge or fuel on a journey far from a charging or fueling station, exceed a maximum safe speed or attempt to exceed a minimum stopping distance and have or cause a vehicle accident.

### SUMMARY

A vehicular road type recognition system improves upon standard trip computers that estimate vehicle range primarily based on battery charge (for electric vehicles) or fuel mileage and remaining fuel (for gas or diesel engines, and hybrids). The system also improves upon published estimates of vehicle performance, by taking into account real-world conditions of roads.

A vehicular road type recognition system of one embodiment has one or more sensors and one or more processors. The one or more sensors produce data relating to road condition. The one or more processors are configured for analyzing the data relating to road condition from the one or more sensors. The one or more processors are configured for determining an estimate of vehicle range, vehicle maximum safe speed, or vehicle braking distance. This determining is based on the analyzing of the data relating to road condition.

A tangible, non-transitory, computer-readable media of one embodiment has instructions. When executed by a processor, the instructions cause the processor to perform a method. In the method, data relating to road conditions is received from one or more sensors of a vehicle. The data relating to road condition, from one or more sensors, is analyzed. Based on the analyzing, an estimate or correction is determined. The estimate or correction is of vehicle range, vehicle maximum safe speed, or vehicle braking distance.

Another embodiment is a method of recognizing road type. The method is practiced by a vehicular road type recognition system. In the method, data relating to road condition is analyzed. The data is from one or more sensors of a vehicle. An estimate or correction is formed of a vehicle range, a vehicle maximum safe speed, or a vehicle braking distance. The estimating or correction is based on the analyzing. The estimated or corrected vehicle range, maximum safe speed or vehicle braking distance is communicated to an operator or occupant of the vehicle.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram of an embodiment of a vehicular road type recognition system that analyzes road types and estimates aspects of vehicle performance such as range, maximum safe speed or braking distance.

FIG. 2 is a diagram of an embodiment of the analysis module of FIG. 1.

FIG. 3 illustrates various factors, sensors and components that are used in various combinations in embodiments of the vehicular road type recognition system of FIG. 1.

FIG. 4 is a flow diagram of a method of recognizing road type, which can be practiced by embodiments of the vehicular road type recognition system of FIG. 1.

### DETAILED DESCRIPTION

A vehicular road type recognition system, in various embodiments described herein, recognizes road types and estimates vehicle performance based on such recognition. Estimates could be outright, or corrections on previous estimates or estimates made by other systems. Improving upon standard trip computers that estimate vehicle range based primarily on battery charge (for electric vehicles), fuel mileage (e.g., for gasoline, diesel or hydrogen engine vehicles) or both (for hybrid or plug-in electric hybrid vehicles), and published but static performance data, the system dynamically calculates estimated vehicle performance and adjusts for changes in road types and other factors affecting vehicle performance.

Some versions receive inputs regarding tires, such as tire pressure, tire pressure changes, sounds, vibration, and/or movement. Some versions use Global Positioning System (GPS) vehicle location information to look at aspects of roads including elevation changes and slope. The system may use other sensors to obtain information about temperature and other environmental conditions affecting roads. Some versions gather information for sections of roads driven repeatedly. The system provides a better battery range estimate (for electric or plug-in electric hybrid vehicles) by knowing the type of road the driver drives on. Also, the system provides for fine-tuning a braking length and adjustment of speed of the vehicle for safety. Some versions provide information for input into an advanced driver assistance system ADAS.

Accelerometers, currently in use as knock sensors for gasoline engines, or in use in airbags, may as well be used to check for vibrations from the road. Sensors could be added, or in some systems, use of information from existing sensors could be expanded. The system could use road recognition information from sensors and data sources to optimize battery range and calculate safe distance for braking.

Yet another use for road recognition information is for such information to be collected from multiple vehicles and stored or further analyzed collectively. This could take place at a server, network connected service provider or other service or facility external to the vehicle(s), for example a cloud service. For example, a service provider could gather road recognition information, which may be of interest to individuals, or organizations, for example a city council, statewide or federal road agency, etc. A twin model simulation could use the same information to deduce from the same inputs the damage from the vehicle to the road, perhaps even charging different toll fees based on this information. Tied to location information, for example obtained through GPS readings, road recognition information could be used for reporting rough roads, potholes or other damage to initiate road repair requests, etc. Further uses for road recognition information, at the vehicle, for example for active suspension tuning, and at a remote site, individualized per vehicle or owner, tied to specific locations or specific roadways, or generalized for regions, may be envisioned and developed.

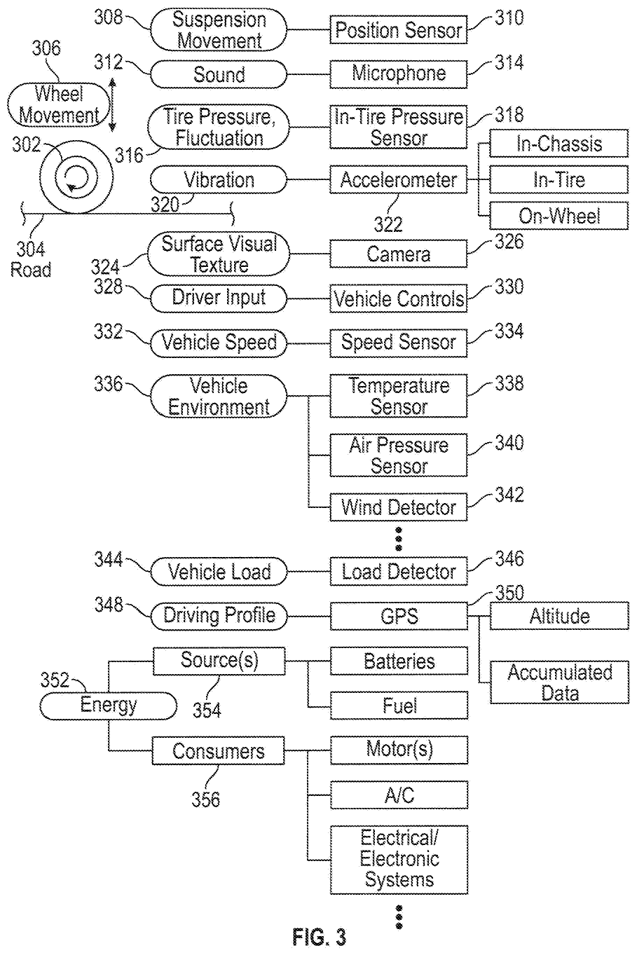

FIG. 1 is a system diagram of an embodiment of a vehicular road type recognition system 102 that analyzes road types and estimates aspects of vehicle performance such as range, maximum safe speed and/or minimum braking distance. One or more processors 104 receive input from sensors 106, battery management 118, motor management 120 and/or electrical/electronic systems management 122. All of this information is processed through an analysis module 108 and an estimator 110 as further described below. The system outputs various estimates of aspects of vehicle performance on a display 112, or optionally an audio output 114 or through a wireless module 116, e.g., to wireless devices such as smart phones, wireless computers, etc. Sensors, aspects of tire and road interaction and vehicle operation, and various analyses that can be performed by the analysis module 108 and the estimator 110 are described below with reference to FIG. 3.

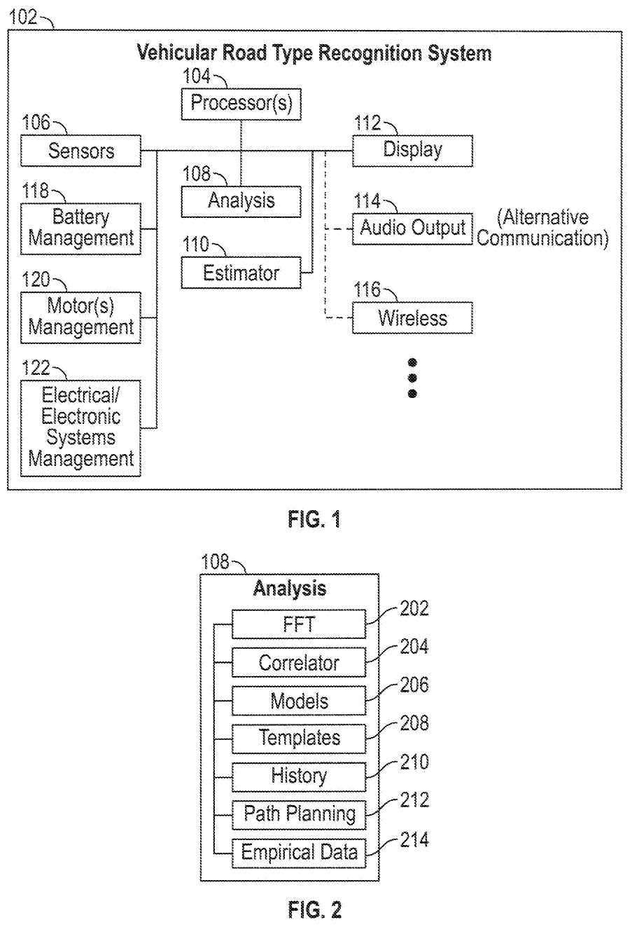

FIG. 2 is a diagram of an embodiment of the analysis module 108 of FIG. 1. Sensor data can be processed through a fast Fourier transform (FFT) module 202, in order to convert (i.e., transform) time domain data to frequency domain data. Time domain data or frequency domain data can be correlated through the correlator 204. Time domain data, frequency domain data, or reduced data, etc., can be compared as to amplitude and/or frequency or other characteristics to models 206, templates 208 or empirical data 214. A history module 210 records aspects of vehicle history, which may include roads traveled, range and performance data relative to those roads, tire age (which affects grip, traction, safe speed and stopping distance), battery age (which affects range), weather and climate information, etc. A path planning module 212 projects road information ahead of present location, such as by interacting with GPS information to obtain waypoints, planned destination and recommended roads on which the vehicle is likely to travel. Variations and further components for the analysis module 108 are readily developed in keeping with the teachings herein.

FIG. 3 illustrates various factors, sensors and components that are used in various combinations in embodiments of the vehicular road type recognition system of FIG. 1. A wheel with tire 302 is shown rotating as a vehicle (not shown) travels along a road 304. Wheel movement 306 gives rise to suspension movement 308, which can be tracked with a position sensor 310 that detects position of a suspension component. Larger wheel movement 306 could be correlated with a rougher road, reduced range, reduced maximum safe speed, and increased stopping distance.

Sound 312 from tire 302 and road 304 interaction can be sensed through a microphone 314. The system could be tuned to detect smooth tire rolling on smooth roads, rough roads, sand or dirt, travel over snow or ice, skidding, cornering at maximum G force with attendant tire squeal, loss of tire traction due to acceleration or braking, etc., each of which has a distinct sound 312 that could be matched through models 206, templates 208 or empirical data 214 in the analysis module 108. A corresponding change in vehicle range, safe speed or stopping distance could be associated to this determination.

Tire pressure 316, as both an average or absolute value and fluctuations in tire pressure 316, can be detected through an in-tire pressure sensor 318. The system could detect road irregularities based on changes in tire pressure, acceleration and temperature, and estimate lower vehicle range and lower safe speed, plus greater stopping distance for too low tire pressures, optimal stopping distance for optimal tire pressure, and greater range but greater stopping distance for too high tire pressures, etc., as matched to models 206, templates 208 or empirical data 214. Tire pressure fluctuation could indicate smooth or rough roads or gravel, or other road textures, and this is correlated with vehicle range, safe speed or stopping distance. Further correlation of tire pressure variation with detection of wheel slippage could refine the detection of road type. For example, very low variation in tire pressure could indicate a smooth road and extension of vehicle range, but when correlated with wheel slippage could indicate ice, in which case estimate of stopping distance should be increased and maximum safe speed should be decreased. High variation in tire pressure could indicate a rough road, and when correlated with wheel slippage could indicate a dirt road or gravel, with attendant increase in stopping distance and reduction in range and maximum safe speed.

Tire sensors e.g., Pressure/Acceleration/Temperature, would give access to road information more quickly than ESP (electronic stability program, also referred to as electronic stability control, ESC) systems alone. Combining ESP and Tire Sensor system for evaluating the road quality would increase the accuracy of the road quality evaluation. In some embodiments, a combined system gives a sanity check of instantaneous road quality recognition. This could improve a database that is generated or updated each time the acceleration is changed (e.g., speeding up or braking).

Vibrations 320, as sensed through an accelerometer 322, gives information about road type. An accelerometer 322 that is in-chassis can give information about vehicle vibration due to road surfaces. An accelerometer 322 that is in-tire can give information about the moment a section of tire tread contacts a road surface. An accelerometer 322 that is on-wheel can give information about wheel movement 306 and road surface. The system detects road texture or irregularities based on the signal from the accelerometer 322. Similarly to information from other types of sensors, this data can be matched to models 206, templates 208 or empirical data to 14 and correlated with vehicle range, safe speed or stopping distance.

Surface visual texture 324 of a road 304 can be sensed through a camera 326, mounted on a vehicle and aimed at a roadway that is in front of, beneath or behind the vehicle. Various machine vision algorithms could be employed for texture analysis, and detection of various types or conditions of road surface, and the results used for estimating vehicle range, speed, maximum safe speed, or stopping distance.

Data from two or more sensors could be correlated through the correlator 204, as time-based data or frequency domain data (e.g., after running through the FFT module 202), for improved accuracy of analysis. Correlated results can be compared with templates 208, models 206 or empirical data 214.

Driver input 328 can be monitored through vehicle controls 330. Smooth and gradual operation of vehicle controls 330, or abrupt or erratic operation, can be detected and used for adjusting vehicle range, safe speed or stopping distance.

Vehicle speed 332 is monitored through a speed sensor 334, for example wheel rotation, transmission shaft rotation or other vehicle speedometer sensing. Alternatively, sonar, radar or lidar could be used to detect vehicle speed 332. Vehicle speed 332 affects vehicle range, safe speed and stopping distance. For example, in addition to numerically or otherwise indicating one of these parameters, as estimated, the system could issue an alert if vehicle speed 332 exceeds the estimated maximum safe speed for a present or upcoming section of road (e.g. through path planning 212). Or, the system could advise the driver when to take a ftiot off the accelerator pedal, apply the brake pedal, or how smoothly or strongly to apply the brake pedal, etc., depending on detected road type.

Vehicle environment 336 is sensed through various sensors, such as a temperature sensor 338, air pressure sensor 340, or wind detector 342. Wind could be detected through comparison of applied power, road or vehicle slope and vehicle speed 332, since wind can slow down (or speed up) a vehicle. An accelerometer 322 could detect wind sway of a vehicle. Effects these environmental aspects have on vehicle range, safe speed or stopping distance could be empirically determined and stored as empirical data 214, or modeled and stored in models 206.

Vehicle load 344 affects vehicle range, safe speed and stopping distance, and can be detected through a load detector 346. For example, a heavy load compresses the suspension, which could be detected through the suspension position sensor 310, or weight detector such as a strain gauge, etc., or inflation of an air suspension, etc. Increase in tire pressure 316 could also be detected as an indication of heavy load. Generally, a lighter load should increase estimate of vehicle range and maximum safe speed and support a low estimate of stopping distance, and a heavier load should decrease estimate of vehicle range and maximum safe speed and increase estimate of stopping distance.

A driving profile 348, in terms of altitude of the vehicle for hills ascent and descent, is obtained from GPS map information associated to positioning information, by a GPS module 350. The history module 210 could store road surface information from multiple journeys over a section of road(s) as accumulated data, and this information can be pulled up for the next travel over a previously traveled road. Also, the path planning module 212 can plan ahead for the next section of roadway, as altitude changes are predicted. This information is then propagated to the estimates of range, since driving uphill decreases range and reduces stopping distance and driving down hills increases range, increases stopping distance, and decreases maximum safe speed.

Energy 352 of a vehicle can be tracked, as relates to sources 354 of energy and consumer 356 of energy. Sources 354 are batteries, for electric, hybrid and plug-in electric vehicles, and/or fuel, for fuel-powered, hybrid or plug-in hybrid vehicles. Consumers 356 include one or more electric motors (for electric, hybrid and plug-in electric hybrid vehicles) or internal combustion engines (for fuel, hybrid or plug-in electric hybrid vehicles), other electric motors, air-conditioning, heat, and electrical or electronic systems, including vehicle operating systems, lights, and entertainment systems such as video or audio. An energy-aware system can determine range based on the net amount of energy available, subtracting consumption from source energy, to predict range, then modify this by the above factors in various embodiments.

Referring back to FIGS. 1 and 2, here is an example operating scenario of the vehicular road type recognition system 102. The analysis module 108 looks at tire pressure and fluctuation in tire pressure, analyzes frequencies and amplitudes and correlates with other signals and other frequencies and amplitudes, from the sensors 106. Correlated data is compared to one or more thresholds, and the analysis module 108 determines that the road is of a specific type. Road friction is estimated, and this is compared to the torque (from energy applied to the wheels) versus wheelspin, e.g., as monitored by a traction control in motor management module 120. Revised road friction is then used for estimates of vehicle range, maximum safe speed and stopping distance.

The vehicular road type recognition system 102 could detect ice using the above analysis, also from temperature sensing, sounds of tires sliding on ice, detection of wheelspin, activation of antilock brakes, traction control, etc. An icy road has less friction, and the system reduces estimates of maximum safe speed and increases estimates of stopping distance accordingly. Other road surfaces such as dust, amount of stone percentage in tarmac, concrete versus asphalt, and reduced traction surfaces in general, can be detected using the above analysis.

With reference to FIGS. 1-3, three stages or phases of operation are envisioned for some embodiments. In phase 1, the vehicular road type recognition system 102 inputs data from sensors 106, calculates vehicle range, maximum safe speed and stopping distance, and compares these to empirical data 214. In phase 2, data is accumulated, for example in the history module 210. Accumulated data is applied for repeated journeys and refined. In some versions, calibration is updated (e.g., through downloads at a service center or wirelessly). In phase 3, information is shared from multiple vehicles, for example through vehicle to vehicle communication, or through a centralized or distributed data center, increasing overall accuracy of the systems. Individual and/or accumulated information can be shared about road types, for example correlated to GPS location information, vehicle dynamics, sensor calibrations, road work, weather conditions, and more as readily devised in keeping with the teachings herein.

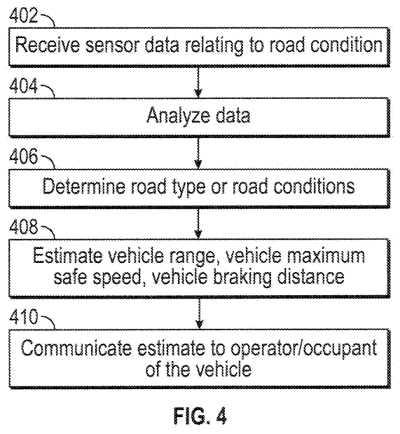

FIG. 4 is a flow diagram of a method of recognizing road type, which can be practiced by embodiments of the vehicular road type recognition system of FIG. 1. More specifically, the method can be practiced by one or more processors in a vehicular road type recognition system.

In an action 402, sensor data is received. The sensor data relates to road condition for a vehicle moving on a road. Various sensors are described above with reference to FIG. 3, and various combinations of sensors can be used to detect various aspects of road conditions.

In an action 404, data from the sensors is analyzed. In some versions, data from sensors is converted to frequency domain data, correlated across the sensors, and correlated or compared to models, templates, history, empirical data or shared data from multiple vehicles.

In an action 408, the system estimates vehicle range, vehicle maximum safe speed and/or vehicle braking distance. How the various factors of road condition and vehicle operation affect these estimates is discussed above with reference to FIG. 3.

In an action 410, the estimate is communicated to the operator or occupant of the vehicle. Mechanisms for such communication are discussed above with reference to FIG. 1, and include displaying, audio output or wireless communication, with parameters, warning or advice given by the system. In a driver assistance vehicle, or driverless vehicle, the estimate could be incorporated into automated control of the vehicle.

With reference to FIGS. 1-4, a detailed operating scenario for a vehicle with an embodiment of the vehicular road type recognition system 102 is described below. This is intended to describe a specific embodiment with reference to components and activities in the system, and is not intended to describe commonalities across all embodiments. Further scenarios, and further embodiments with various mixes of features are readily devised in keeping with the teachings herein.

The vehicle starts off traveling on a road for which there is vehicle history data in the history module 210. The estimator 110 pulls up historical recommendations for vehicle range, safe speed and stopping distance, and modifies vehicle range based on the latest estimates of energy 352 (e.g., batteries and/or fuel), vehicle speed 332 from the speed sensor 334 and vehicle environment 336 from the temperature sensor 338, air pressure sensor 340, and wind detector 342, and vehicle load 344 from the load detector 346. Along the way, the position sensor 310 picks up suspension movement 308, the microphone 314 picks up sound 312 from vehicle and roadway interaction, and the in-tire pressure sensors 318 picks up tire pressure 316 and tire pressure fluctuation. Surface visual texture 324 is observed by the camera 326. Data from each of these is run through the FFT module 202, so that the analysis module 108 can analyze frequencies and amplitudes, and correlate, using the correlator 204, such analysis among the sensors 106 and with the models 206, templates 208, and also with empirical data 214 and history data from the history module 210. The analysis module 108 then coordinates with the estimator 110, which produces revised estimates for vehicle range, safe speed and stopping distance, lowering the vehicle range and safe speed, and increasing the estimated stopping distance, upon detecting rough road conditions. Later, the above analysis (which is running continuously) by the analysis module 108 determines the road conditions have improved and are smoother, and the estimator 110 revises upward the estimate for vehicle range and safe speed, and revises downward the estimate for stopping distance. Still later in the journey, the above analysis by the analysis module 108 determines the road conditions have snow, which is characterized by a particular sound 312, suspension movement 308 and colder temperature from the temperature sensor 338, followed by ice, which is characterized by a different sound 312, suspension movement 308 and tire slippage, also at colder temperatures. The estimator 110 revises downward the estimate for vehicle range and safe speed, and revises upward the estimate for stopping distance. This information for vehicle range, safe speed and stopping distance are reported (i.e., communicated) through the display 112 to the operator or an occupant of the vehicle, and optionally (e.g., through user selection) communicated through the audio output 114 or wireless module 116, e.g., to a smart phone. Observing this, the driver then reduces the speed of the vehicle (or, the driverless or assisted driving car reduces its own speed). A particularly sudden suspension movement and tire pressure increase and decrease are detected through the above sensors 106 and analysis module 108 (e.g., through the FFT module 202 detecting something like a delta spike or pair of step transitions, and correlating through the correlator tool for with models 206, templates 208 or empirical data 214 suggesting categories). This is analyzed by the analysis module 108 and determined to be indicative of a large pothole, which is then reported through the wireless module 116 to initiate a road repair request, and recorded in the history module 210 for monitoring and possible warning the next time the vehicle is on that same roadway.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or limiting. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive.

What is claimed is:

1. A vehicular road type recognition system, comprising:
one or more sensors, to produce data relating to road condition; and
one or more processors, configured for:
analyzing the data relating to road condition from the one or more sensors; and
determining, based on the analyzing, an estimate or correction of at least one of: a vehicle range, a vehicle maximum safe speed, or a vehicle braking distance.

2. The vehicular road type recognition system of claim 1, wherein the analyzing comprises:
analyzing frequency and amplitude of the data relating to road condition, to determine a type of road surface, wherein the determining the estimate is based on the determined type of road surface.

3. The vehicular road type recognition system of claim 1, wherein:
the one or more sensors comprise an in-tire pressure sensor, and
the analyzing comprises detecting road irregularities based on changes in tire pressure from the in-tire pressure sensor.

4. The vehicular road type recognition system of claim 1, wherein:
the one or more sensors comprises a microphone; and
the analyzing comprises detecting tire and road interaction based on acoustic signal from the microphone.

5. The vehicular road type recognition system of claim 1, wherein:
the one or more sensors comprises an accelerometer; and
the analyzing comprises detecting road texture or irregularities based on a signal from the accelerometer.

6. The vehicular road type recognition system of claim 1, wherein:
the one or more sensors comprises a camera; and
the analyzing comprises detecting types of road surface based on data from the camera.

7. The vehicular road type recognition system of claim 1, wherein:
the analyzing comprises using a fast Fourier transform (FFT) to transform the data from the one or more sensors to frequency domain data, and correlating the frequency domain data with templates, models, empirical data or frequency domain data from one or more further sensors.

8. The vehicular road type recognition system of claim 1, wherein:
the determining is further based on comparison of estimated road friction to applied wheel torque or detected wheelspin.

9. The vehicular road type recognition system of claim 1, wherein:
the determining is further based on altitude or accumulated data associated to Global Positioning System (GPS) information.

10. A tangible, non-transitory, computer-readable media having instructions thereupon which, when executed by a processor, cause the processor to perform a method comprising:
receiving data relating to road condition from one or more sensors of a vehicle;
analyzing the data relating to road condition from the one or more sensors; and
determining, based on the analyzing, an estimate or correction of at least one of: a vehicle range, a vehicle maximum safe speed, or a vehicle braking distance.

11. The computer-readable media of claim 10, wherein:
the analyzing comprises analyzing frequency and amplitude of the data relating to road condition, to determine a type of road surface; and
the determining the estimate is based on the determined type of road surface.

12. The computer-readable media of claim 10, wherein the receiving data from one or more sensors of the vehicle comprises receiving data from at least two sensors of differing types, from a set consisting of a camera, an in-tire pressure sensor, a microphone, and an accelerometer.

13. The computer-readable media of claim 10, wherein the analyzing comprises:
transforming, using a fast Fourier transform (FFT), the data from each of two or more sensors to frequency domain data of the two or more sensors;
correlating the frequency domain data of the two or more sensors with each other to produce correlation results; and
comparing the correlation results with templates, models, or empirical data.

14. The computer-readable media of claim 10, wherein the method further comprises:
determining an estimate of road friction, based on the analyzing; and
comparing the estimate of road friction to applied wheel torque or detected wheelspin, wherein the determining the estimate of the at least one of a vehicle range, a vehicle maximum safe speed, or a vehicle braking distance is further based on the comparing.

15. The computer-readable media of claim 10, wherein the method further comprises:
receiving Global Positioning System (GPS) information; and
determining altitude or road condition for a location of the vehicle, based on the GPS information, wherein the determining the estimate is further based on the determined altitude or road condition.

16. A method of recognizing road type, practiced by a vehicular road type recognition system, comprising:
analyzing data relating to road condition from one or more sensors of a vehicle; and
estimating or correcting, based on the analyzing, at least one of: a vehicle range, a vehicle maximum safe speed, or a vehicle braking distance; and
communicating the estimated at least one of a vehicle range, a maximum safe speed, or a vehicle braking distance to an operator or occupant of the vehicle.

17. The method of claim 16, further comprising:
sharing information from multiple vehicles regarding road types, vehicle dynamics or sensor calibrations, and wherein the analyzing comprises:
analyzing frequency and amplitude of the data from the one or more sensors; and
determining a type of road surface, based on the analyzing and the shared information from multiple vehicles, wherein the estimating is based on the determined type of road surface.

18. The method of claim 16, wherein:
the analyzing comprises detecting road irregularities based on changes in tire pressure from an in-tire pressure sensor; and
the estimating is based on the analyzing and further based on information relating the vehicle range, the vehicle maximum safe speed, or the vehicle braking distance to tire pressure.

19. The method of claim 16, wherein the analyzing comprises detecting tire and road interaction based a signal from a microphone or an accelerometer.

20. The method of claim 16, wherein the analyzing comprises detecting types or conditions of road surface based on data from a vehicle-mounted camera.
